(19) United States
(12) Patent Application Publication
(10) Pub. No.: US 2021/0326155 A1
(43) Pub. Date: Oct. 21, 2021

(54) SYSTEMS AND METHODS FOR ASSISTIVE USER INTERFACES

(71) Applicant: Capital One Services, LLC, McLean, VA (US)

(72) Inventors: Jeremy GOODSITT, Champaign, IL (US); Vincent PHAM, Champaign, IL (US); Mark WATSON, Sedona, AZ (US); Anh TRUONG, Champaign, IL (US); Austin WALTERS, Savoy, IL (US)

(21) Appl. No.: 16/848,900

(22) Filed: Apr. 15, 2020

(51) Int. Cl. G06F 9/451; G06F 3/023; G06F 3/0488

(52) U.S. Cl. CPC G06F 9/453; G06F 3/04883; G06F 3/0237

(57) ABSTRACT

An exemplary system, method, and computer-accessible medium can include, assigning first location data to a first object at a first location on a display screen and assigning second location data to a second object at a second location on the display screen, receiving an input(s) from a user(s) for a selection of the first object, applying a predictive model to determine if the selection was intended for a second object on the display screen at a second location, wherein the determination is based on the first location data and the second location data, and selecting the second object based on the determination. A determination can be made as to whether the selection was intended for the second object based on prior behavior for the user(s) related to the selection of the second object.

### FIELD OF THE INVENTION

This disclosure relates to user/device interaction, and more specifically, to systems, methods, and computer-accessible mediums for assistive user interfaces.

### BACKGROUND

Electronic devices are ubiquitous in modern society. The proliferation of personal electronic devices, such as smart phones, smart watches, laptop computers, tablets, along with smart appliances, vehicles containing electronic devices, automated teller machines, and other electronic devices, means users are interacting electronic devices more than ever. A user can interact with a number of electronic devices using a variety of input devices each day. In many ways, electronic devices have promoted convenience and efficiencies in the operations and transactions that users must perform.

Some, if not all of this convenience and efficiency can be realized only if the user is proficient in using an electronic device and does not make errors. Common errors include pressing a wrong button, checking an incorrect box, making an incorrect selection, or tapping an unintended portion of the screen. Thus, an individual that is not proficient in using the electronic device cannot perform operations efficiencies and worse, can inadvertently perform unwanted transactions or take unnecessary actions that require time and money to remedy.

Users can lack proficiency with electronic devices for a number of reasons. For example, a user can lack proficiency with an electronic devices due to lack of experience with a particular type of electronic device, with a particular model of electronic device, or with electronic devices in general. As another example, a user can lack proficiency with electronic devices due to a physical or mental disability. For such users, electronic devices cannot be convenient or efficient, and instead can be difficult and frustrating. In addition, the inability to proficiently use electronic devices can be detrimental to a user's personal life and become a hindrance to his or her employment and career.

In addition, both proficient and non-proficient users can have difficulty and/or make mistakes when interacting with a graphical user interface. For example, a mouse cursor, also known as a mouse arrow, or mouse pointer, is a graphical image that can be used to activate or control certain elements in a graphical user interface. It can indicate where the mouse should perform its next action, such as opening a program, or dragging a file to an-other location. When a user wishes to select an object on a display screen, they can use a physical device (e.g., a mouse, a trackpad, or a roller ball) to move the mouse cursor over the object. Because a mouse cursor is relatively small, it can be easy to select both large and small objects on the display screen, and these selections can be made accidentally or intentionally. As another example, touch screens have become more prevalent. Presently there are millions of devices that are touchscreen-based devices, which rely on the user to use their finger, specifically their fingertip), to select objects on a display screen.

For both mouse-based and touch-screen devices, if the screen is a large screen, then a mouse or a fingertip can be precise in the selection of an object. Additionally, if the object is relatively large, then it can be easy to select on object. However, small objects on a small screen can be notoriously difficult to select using a mouse or a fingertip. For example, a link on a small screen (e.g., a tablet or a mobile phone), can be extremely difficult to select, especially when surrounded by other links. This can also be true for graphical user interfaces that are not adapted to small screens or mobile devices or that fail to display correctly for another reason. Thus, it is common for a user to attempt to select one link but the device processes the selection of a different link due to the proximity.

These and other deficiencies exist, and accordingly, there is a need for user interfaces that can assist users to use electronic devices proficiently. By doing so, users with all levels of proficiency with electronic devices can be able to use such devices effectively and efficiently.

### SUMMARY

Therefore, it is an object of this disclosure to describe systems and methods for assistive user interfaces. Various embodiments describe systems and methods for generating user interfaces that can monitor a user's interaction with the interface and build a predictive model based on the user's correct inputs and the user's mistaken inputs that are subsequently corrected. The predictive model can be built such that, upon receipt by the interface of a mistaken input, the model can determine the user's intent and correct the input on the user's behalf. Thus, through the provision of an assistive user interface according to example embodiments of the present disclosure, users of all levels of proficiency can more effectively and more efficiently interact with electronic devices in personal and professional settings. In addition, assistive interfaces according to example embodiments of the present disclosure can enable users having physical and mental disabilities to use electronic devices with reduced or eliminated difficulty.

Embodiments of the present disclosure provide a non-transitory computer-accessible medium having stored thereon computer-executable instructions wherein, when a computer hardware arrangement executes the instructions, the computing arrangement is configured to perform procedures comprising: assigning first location data to a first object at a first location on a display screen and assigning second location data to a second object at a second location on a display screen; receiving at least one input from at least one user for a selection of the first object on a display screen at a first location; applying a predictive model to determine if the selection was intended for the second object on the display screen, wherein the determination is based on the first location data and the second location data; and selecting the second object based on the determination.

Embodiments of the present disclosure provide a method, comprising: receiving a first input from a user for a selection of a first webpage link; loading the first webpage link; receiving a second input from the user to go back to a previous webpage; receiving a third input from the user for the selection of a second webpage link; loading the second webpage link; storing, in a database, an entry for a mishit associated with the selection of the first webpage link, wherein the entry for the mishit associated with the selection of the first webpage link is categorized as a negative reinforcement; and storing, in the database, an entry for a hit associated with the selection of the second webpage link, wherein and the entry for the hit associated with the selection of the second webpage link is categorized as a positive reinforcement.

Embodiments of the present disclosure provide a system, comprising: a display device configured to display a first object at a first location on the display device and a second object at a second location on the display device, wherein the first location is different from the second location; an input device configured to receive an input from a user for a selection of the second object; an interaction database containing usage data relating to one or more user interactions with one or more objects; and a computing arrangement configured to: assign first location data to the first object and assign second location data to the second object; apply a predictive model to determine if the selection was intended for the first object, wherein the determination is based on the location data and interaction data contained in an interaction database; and select the first object based on the determination.

These and other objects, features and advantages of the example embodiments of the present disclosure will become apparent upon reading the following detailed description of the exemplary embodiments of the present disclosure, when taken in conjunction with the appended claims.

### BRIEF DESCRIPTION OF THE DRAWINGS

FIG. 1 illustrates an assistive interface system according to an example embodiment.

FIG. 2 illustrates a sequence for the operation of an assistive user interface according to an example embodiment.

FIG. 3 illustrates a database schema for an interaction database according to an example embodiment.

FIG. 4 illustrates a flow diagram for a method of collecting and entering usage data according to an example embodiment.

FIG. 5 illustrates an interface according to an example embodiment.

FIG. 6 illustrates an interface according to an example embodiment.

FIG. 7 illustrates an interface according to an example embodiment.

FIG. 8 illustrates a flow diagram for a method of operating an assistive interface according to an example embodiment.

FIG. 9 illustrates a flow diagram for a method of operating an assistive interface according to an example embodiment.

### DETAILED DESCRIPTION OF EXAMPLE EMBODIMENTS

Aspects of the present disclosure including providing an assistive user interface and further include providing systems, methods, and computer-accessible mediums for assisting a user interact with an interface through the user of a predictive model.

System, methods, and computer-accessible mediums according to example embodiments can be used to track user input into a device (e.g., touch input, mouse input, etc.), and correct for any mishits or misselections by the user of a particular object. For example, when a user selects an object on a screen (e.g., an icon, a link, a picture, etc.), the exemplary system, method, and computer-accessible medium can determine if the user intended to select a different object, based on, for example, the proximity of the first object to the second object. Thus, the user does not need to reselect the correct object, which can require the user to browse backwards on a webpage and attempt to select the correct object. The exemplary system, method, and computer-accessible medium can track prior behavior of the user, and prior behavior of other users for the same or similar content, to determine if the selection was the correct selection, or if the user intended to select a different object. As used herein, an object or an element can refer to any object or element on a display screen that can be selected by user. For example, an object can include, but is not limited to, a hyperlink, an icon, a picture, text, radio buttons, check boxes, etc.

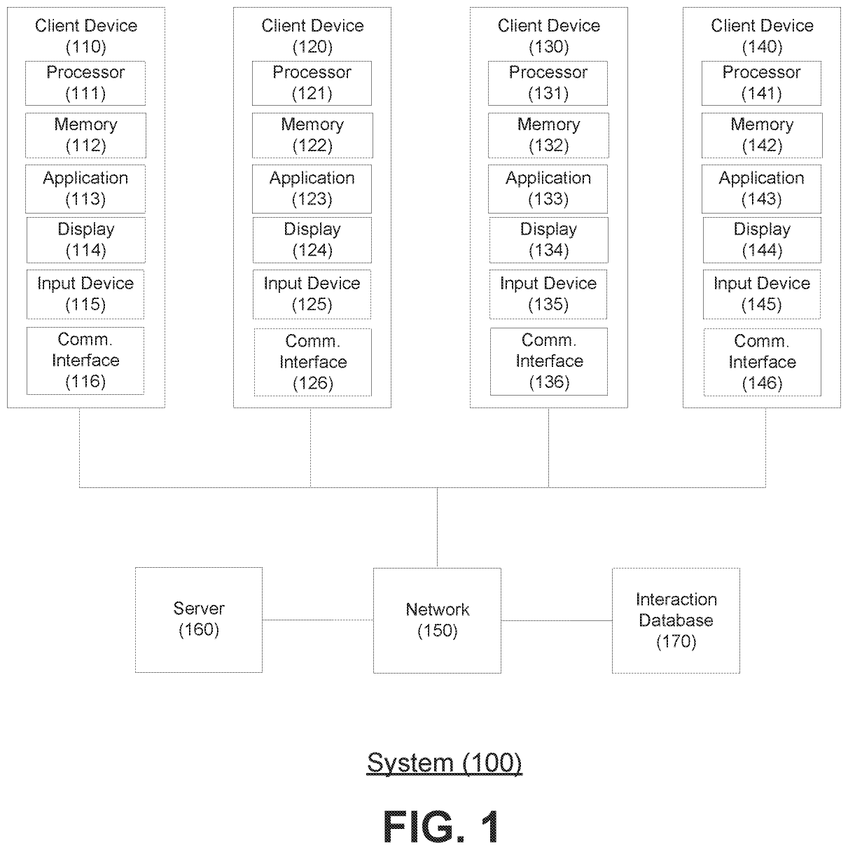

FIG. 1 illustrates an assistive interface system 100 according to an example embodiment of the systems, methods, and computer-accessible mediums disclosed herein. In this embodiment, the system includes client devices 110, 120, 130, 140 that can communicate through network 150 with a server 160, and an interaction database 170. For example client device 110 can be a smartphone, client device 120 can be a tablet, client device 130 can be a desktop computer, and client device 140 can be a wearable device (e.g., a smart watch). It is understood that client devices 110, 120, 130, 140 are not limited to these examples, and client devices 110, 120, 130, 140 can be any combination of one or more electronic devices selected from the group of smartphones, laptop computers, desktop computers, tablet computers, personal digital assistants, wearable devices, smartcards, thin clients, fat clients, servers, Internet browsers, and customized software applications. It is further understood that the client devices can be of any type of electronic device that supports the communication and display of data and user input, including commercial and industrial devices. Additional exemplary embodiments include, without limitation, automated teller machines (ATMs), kiosks, checkout devices, registers, navigation devices (e.g., Global Positioning System devices), music players, audio/visual devices (e.g., televisions and entertainment systems), electronic devices integrated in vehicles (e.g., dashboard displays, climate controls, sound systems), and industrial machinery. While the example embodiment illustrated in FIG. 1 shows client devices 110, 120, 130, 140, the present disclosure is not limited to a specific number of client devices, and it is understood that the system 100 can include a single client device or any number of client devices.

As shown in FIG. 1, the client device 110 can include a processor 111, a memory 112, an application 113, a display 114 and input devices 115. The processor 111 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 111 can be coupled to the memory 112. The memory 112 can be a read-only memory, write-once read-multiple memory or read/write memory, e.g., RAM, ROM, and EEPROM, and client device can include one or more of these memories. A read-only memory can be factory programmable as read-only or one-time programmable. One-time programmability provides the opportunity to write once then read many times. A write once/read-multiple memory can be programmed at a point in time after the memory chip has left the factory. Once the memory is programmed, it cannot be rewritten, but it can be read many times. A read/write memory can be programmed and re-programed many times after leaving the factory. It can also be read many times. The memory 112 can be configured to store one or more software applications, such as application 113, and other data.

The application 113 can comprise one or more software applications comprising instructions for execution on the client device 105. In some examples, client device 110 can execute one or more applications, such as software applications, that enable, for example, network communications with one or more components of system 100, transmit and/or receive data, and perform the functions described herein. Upon execution by the processor 111, the application 113 can provide the functions described in this specification, specifically to execute and perform the steps and functions in the process flows described above. Such processes can be implemented in software, such as software modules, for execution by computers or other machines. The application 113 can provide graphic user interfaces (GUIs) through which user can view and interact with other components and devices within system 100. The GUIs can be formatted, for example, as web pages in HyperText Markup Language (HTML), Extensible Markup Language (XML) or in any other suitable form for presentation on a display device depending upon applications used by users to interact with the system 100.

The client device 110 can further include a display 114 and an input device 115. The display 114 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input device 115 can include one or more of any device for entering information into the client device 110 that is available and supported by the client device 110. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. Input device 115 can be used to enter information and interact with the client device 110 and by extension with the systems and software described herein.

Client device 110 can further include a communication interface 116 having wired and/or wireless data communication capabilities. These capabilities can support data communication with a wired or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 116 can also support a short-range wireless communication interface, such as near field communication, radio-frequency identification, and Bluetooth.

The client device 120 can include a processor 121, a memory 122, an application 123, a display 124 and input devices 125. The processor 121 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 121 can be coupled to the memory 122. The memory 122 can be a read-only memory, write-once read-multiple memory or read/write memory, e.g., RAM, ROM, and EEPROM, and client device can include one or more of these memories. A read-only memory can be factory programmable as read-only or one-time programmable. One-time programmability provides the opportunity to write once then read many times. A write once/read-multiple memory can be programmed at a point in time after the memory chip has left the factory. Once the memory is programmed, it cannot be rewritten, but it can be read many times. A read/write memory can be programmed and re-programed many times after leaving the factory. It can also be read many times. The memory 122 can be configured to store one or more software applications, such as application 123, and other data.

The application 123 can comprise one or more software applications comprising instructions for execution on the client device 105. In some examples, client device 120 can execute one or more applications, such as software applications, that enable, for example, network communications with one or more components of system 100, transmit and/or receive data, and perform the functions described herein. Upon execution by the processor 121, the application 123 can provide the functions described in this specification, specifically to execute and perform the steps and functions in the process flows described above. Such processes can be implemented in software, such as software modules, for execution by computers or other machines. The application 123 can provide graphic user interfaces (GUIs) through which user can view and interact with other components and devices within system 100. The GUIs can be formatted, for example, as web pages in HyperText Markup Language (HTML), Extensible Markup Language (XML) or in any other suitable form for presentation on a display device depending upon applications used by users to interact with the system 100.

The client device 120 can further include a display 124 and an input device 125. The display 124 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input device 125 can include one or more of any device for entering information into the client device 120 that is available and supported by the client device 120. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. Input device 125 can be used to enter information and interact with the client device 120 and by extension with the systems and software described herein.

Client device 120 can further include a communication interface 126 having wired and/or wireless data communication capabilities. These capabilities can support data communication with a wired or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 126 can also support a short-range wireless communication interface, such as near field communication, radio-frequency identification, and Bluetooth.

The client device 130 can include a processor 131, a memory 132, an application 133, a display 134 and input devices 135. The processor 131 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 131 can be coupled to the memory 132. The memory 132 can be a read-only memory, write-once read-multiple memory or read/write memory, e.g., RAM, ROM, and EEPROM, and client device can include one or more of these memories. A read-only memory can be factory programmable as read-only or one-time programmable. One-time programmability provides the opportunity to write once then read many times. A write once/read-multiple memory can be programmed at a point in time after the memory chip has left the factory. Once the memory is programmed, it cannot be rewritten, but it can be read many times. A read/write memory can be programmed and re-programed many times after leaving the factory. It can also be read many times. The memory 132 can be configured to store one or more software applications, such as application 133, and other data.

The application 133 can comprise one or more software applications comprising instructions for execution on the client device 105. In some examples, client device 130 can execute one or more applications, such as software applications, that enable, for example, network communications with one or more components of system 100, transmit and/or receive data, and perform the functions described herein. Upon execution by the processor 131, the application 133 can provide the functions described in this specification, specifically to execute and perform the steps and functions in the process flows described above. Such processes can be implemented in software, such as software modules, for execution by computers or other machines. The application 133 can provide graphic user interfaces (GUIs) through which user can view and interact with other components and devices within system 100. The GUIs can be formatted, for example, as web pages in HyperText Markup Language (HTML), Extensible Markup Language (XML) or in any other suitable form for presentation on a display device depending upon applications used by users to interact with the system 100.

The client device 130 can further include a display 134 and an input device 135. The display 134 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input device 135 can include one or more of any device for entering information into the client device 130 that is available and supported by the client device 130. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. Input device 135 can be used to enter information and interact with the client device 130 and by extension with the systems and software described herein.

Client device 130 can further include a communication interface 136 having wired or wireless data communication capabilities. These capabilities can support data communication with a wired or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 136 can also support a short-range wireless communication interface, such as near field communication, radio-frequency identification, and Bluetooth.

The client device 140 can include a processor 141, a memory 142, an application 143, a display 144 and input devices 145. The processor 141 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 141 can be coupled to the memory 142. The memory 142 can be a read-only memory, write-once read-multiple memory or read/write memory, e.g., RAM, ROM, and EEPROM, and client device can include one or more of these memories. A read-only memory can be factory programmable as read-only or one-time programmable. One-time programmability provides the opportunity to write once then read many times. A write once/read-multiple memory can be programmed at a point in time after the memory chip has left the factory. Once the memory is programmed, it cannot be rewritten, but it can be read many times. A read/write memory can be programmed and re-programed many times after leaving the factory. It can also be read many times. The memory 142 can be configured to store one or more software applications, such as application 143, and other data.

The application 143 can comprise one or more software applications comprising instructions for execution on the client device 105. In some examples, client device 140 can execute one or more applications, such as software applications, that enable, for example, network communications with one or more components of system 100, transmit and/or receive data, and perform the functions described herein. Upon execution by the processor 141, the application 143 can provide the functions described in this specification, specifically to execute and perform the steps and functions in the process flows described above. Such processes can be implemented in software, such as software modules, for execution by computers or other machines. The application 143 can provide graphic user interfaces (GUIs) through which user can view and interact with other components and devices within system 100. The GUIs can be formatted, for example, as web pages in HyperText Markup Language (HTML), Extensible Markup Language (XML), or in any other suitable form for presentation on a display device depending upon applications used by users to interact with the system 100.

The client device 140 can further include a display 144 and an input device 145. The display 144 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input device 145 can include one or more of any device for entering information into the client device 140 that is available and supported by the client device 140. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. Input device 145 can be used to enter information and interact with the client device 140 and by extension with the systems and software described herein.

Client device 140 can further include a communication interface 146 having wired or wireless data communication capabilities. These capabilities can support data communication with a wired or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 146 can also support a short-range wireless communication interface, such as Near Field Communication (NFC), Radio-Frequency Identification (RFID), and Bluetooth.

Network 150 can be one or more of a wireless network, a wired network, or any combination of wireless network and wired network. For example, network 150 can include at least one selected from the group of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.l, 802.11n and 802.11g, NFC, (RFID), Bluetooth, Wi-Fi, and/or the like.

In addition, network 150 can include, without limitation, telephone lines, fiber optics, IEEE Ethernet 902.3, a wide area network, a wireless personal area network, a LAN, or a global network such as the Internet. In addition, network 150 can support an Internet network, a wireless communication network, a cellular network, or the like, or any combination thereof. Network 150 can further include one network, or any number of the exemplary types of networks mentioned above, operating as a stand-alone network or in cooperation with each other. Network 150 can utilize one or more protocols of one or more network elements to which they are communicatively coupled. Network 150 can translate to or from other protocols to one or more protocols of network devices. Although network 150 is depicted as a single network, it should be appreciated that according to one or more examples, network 150 can comprise a plurality of interconnected networks, such as, for example, the Internet, a service provider's network, a cable television network, corporate networks, such as credit card association networks, and home networks.

Server 160 can be a dedicated server computer, such as bladed servers, or can be personal computers, laptop computers, notebook computers, palm top computers, network computers, mobile devices, wearable devices, smartcards, or any processor-controlled device capable of supporting the system 100. While FIG. 1 illustrates a single server 160, it is understood that other embodiments can use multiple servers or multiple computer systems as necessary or desired to support the users and can also use back-up or redundant servers to prevent network downtime in the event of a failure of a particular server.

Interaction database 170 can be a relational database, a non-relational database, or a combination of more than one database and more than one type of database. The interaction database 170 can be stored by and/or in data communication with one or more of the client devices 110, 120, 130, 140 and In an embodiment, the interaction database 170 can be stored by server 160, alternatively the interaction database 170 can be stored remotely, such as in another server, on a cloud-based platform, or in any storage device that is in data communication with server 160. In other embodiments, the interaction database 170 can be stored by one or more of the client devices 110, 120, 130, 140, and the interaction database 170 can be stored remotely in any storage devices that is in data communication with the client devices 110, 120, 130, and 140 and/or server 160. Data communication between these devices and the interaction database 170 can be via network 150.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the client devices 110, 120, 130, and 140 and/or server 160 or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

Graphical user interfaces according to example embodiments can comprise one or more objects or elements displayed by the client devices, for example client device 110. Exemplary objects or elements include, without limitation, widgets, windows, window borders, buttons, icons, menus, tabs, scroll bars, zooming tools, dialog boxes, check boxes, radio buttons, hyperlinks, and text. The interface can be displayed by, e.g., an application installed on or a webpage loaded by the client device 110. The placement of, and user interaction with, objects or elements within the interface can be recorded by the application 113 and stored as usage data in interaction database 170. The user can interact with the one or more objects or elements when using the interface in various ways, including without limitation moving and/or clicking a mouse or other input device, clicking a button, entering text, selecting text, editing text (e.g., adding text, changing text, or deleting text), editing the format of text (e.g., bolding, italicizing, underlining, increasing/decreasing text size, changing a font, or removing formatting), making selections from a menu, checking a box, unchecking a box, turning a feature or functionality on, turning a feature or functionality off, using a scroll bar, and the like. These interactions, and the sequence of interactions, can also be recorded by the interaction database 170. It is understood that example embodiments of the assistive interfaces and predictive models described herein can be applied to any interaction and sequence of interactions, including the foregoing examples. A reference to a specific action, such as clicking a button or selecting a link, is understood to be non-limiting and can refer to any interaction and sequence of interactions, including the foregoing examples.

The data contained in the interaction database 170 can be used to train a predictive model to determine the action the user intended by the user. The user's interactions with interface following an initial action can be viewed as positive or negative reinforcement for an initial action. For example, a user can click a first button that causes a new screen to be displayed and then click on a second button on the new screen to perform a task. The subsequent click on the second button on the second screen can be considered positive reinforcement of the click of the first button. Due to this positive reinforcement, clicking the first button can be considered to be what the user intended. In a contrasting example, user can click on the first button to cause a new screen to be displayed and, instead of clicking the second button, the user can click on a back button or otherwise navigate back to the first screen in order to click on a different button located nearby the first button. In this example, the immediate return to the previous screen and clicking of a different by nearby button can be considered a negative reinforcement of the click on the first button. Due to this negative reinforcement, clicking the first can be considered accidental or unintentional and contrary to what the user intended.

Through the accumulation of usage data in interaction database 170, the predictive model can be trained. The predictive model can be a predictive modeling framework developed by machine learning. In an embodiment, the predictive model can be a supervised learning model with a specified target and features. The target of the model can be whether the user intended to perform an action, such as a button click or a menu selection. The features of the model can be selected from the usage data stored in the interaction database 170, including usage data considered to be positive reinforcement and negative reinforcement of user actions. In addition, the usage data used for training the predictive model can increase, can decrease, or can otherwise be modified over time as the development of the predictive model continues. In some examples, the predictive model can develop profiles and behavior patterns associated with one or more users.

In some examples, interaction database 170 can contain information relating to the use of one or more of the client devices 110, 120, 130, 140 used by the user. Including information from the use of multiple devices can improve the training and operation predictive model by providing additional insight in the form of the user's interactions with different devices. In some examples, interaction database 170 can contain information aggregated from one or more different users and/or one or more different client devices. By doing so, the initial training and operation of the predictive model can be more quickly initially trained and subsequently improved as additional data is collected relating to the particular user of the client devices 110, 120, 130, 140. Further, as the collection of data relating to the particular user of the client devices 110, 120, 130, 140 continues, aggregated data from other users and/or other client devices can be gradually removed from the interaction database 170. Alternatively, all aggregated data from other users and/or other client devices can be removed at one point upon reaching a threshold amount of information relating to the particular user of the client devices 110, 120, 130, 140.

The predictive model can be developed by machine learning algorithms. In an embodiment, the machine learning algorithms employed can include at least one selected from the group of gradient boosting machine, logistic regression, neural networks, and a combination thereof, however, it is understood that other machine learning algorithms can be utilized. In an embodiment, the predictive model can be developed using foundational testing data generated by randomly selecting usage data and positive negative random sample of users of client devices.

The predictive model can include continuous learning capabilities. In some examples, the interaction database 170 can be continuously updated as new usage data is collected. The new usage data can be incorporated into the training of the predictive model, so that the predictive model reflects training based on usage data from various points in time. For example, the training can include usage data collected from within a certain time period (e.g., the three months or the past year). As another example, the training can include only usage data that has been recently collected (e.g., within the past day, week, or month).

Initially, there cannot be sufficient foundational testing data available to develop the predictive model. Accordingly, the initial model development can be performed using predetermined actions as a proxy target and usage data available from other sources as features (e.g., usage data collected from other users of the same or similar client devices and usage data from the instant user of the same or similar client devices). By doing so, the predictive model can begin to form its understanding of user actions and usage data. The results of this initial modeling can support the initial status of the predictive model, and the model can be continuously improved as usage data from a specific user and/or newer usage data becomes available.

Once trained, the predictive model can be utilized to correct mistakes and unintentional actions performed by the user. For example, if the user frequently clicks a first button but in a specific instance clicks on a second button that is adjacent to the first button, the predictive model can identify the click on the second button as an error or a potential error. In response, the predictive model can initiate a corrective action, such as causing the interface to respond as if the first button had been clicked or presenting a notification asking if the user intended to click the first button.

In some examples, the predictive model can be stored on one or more of the client devices 110, 120, 130, 140. Locally storing the model can realize the benefit of reduced response times where predictions and corrective actions can be more quickly issued. In other examples, the predictive model can be stored on the server 160, which can allow for centralized maintenance of the predictive model and greater accessibility of the model for training. In examples where the predictive model is locally stored, the predictive model can be trained on server 160 and synchronized across the client devices 110, 120, 130, 140. Alternatively, the predictive model can be trained continuously when locally stored and synchronized across client devices 110, 120, 130, 140.

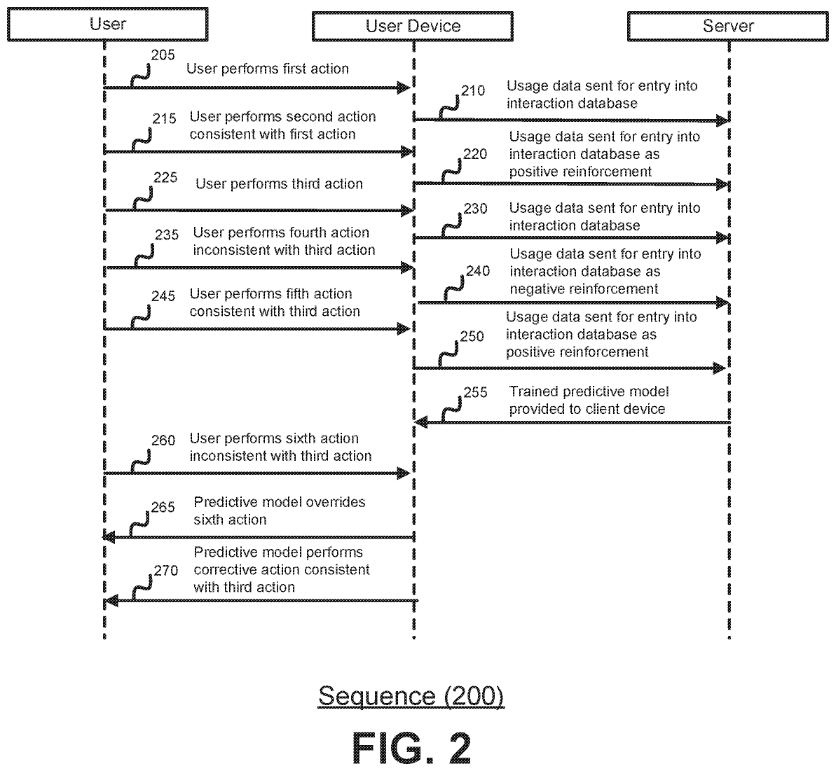

FIG. 2 illustrates a sequence 200 for the operation of an assistive interface according to an example embodiment of the systems, methods, and computer-accessible mediums disclosed herein. FIG. 2 can reference the same or similar components as described with respect to other figures, including a user device, a server, an interaction database, a predictive model, and a network.

The sequence 200 can commence in step 205 with the user performing a first action, such as clicking a button, entering or selecting text, making selections from a menu, and or a scroll bar. The first action can be recorded as usage data by an application executing on the user device and can be transmitted to a server via a network for entry into an interaction database in step 210. Although not shown in FIG. 2, it is understood that the user device can transmit the usage data directly to the interaction database for entry via a network. It is further understood that the interaction database can be stored locally on the user device, such that no network communication is necessary for usage data to be entered into the interaction database.

In step 215, the user can perform a second action, and the second action can be consistent with the first action. For example, if the first action is clicking a button that displays a different screen and the second action is clicking on a second button on the different screen to perform a task, the second action can be considered to be consistent with the first action. As another example, if the first action is to make a selection from a menu and the second action is to make a selection from a sub-menu revealed by the menu selection, the second action can be considered to be consistent with the first action. The second action can be recorded as usage data by the application and can be transmitted to a server via a network for entry into an interaction database in step 220. The entry of the usage data relating to the second action can indicate that this action is considered positive reinforcement for the first action.

In step 225, the user can perform a third action, and in step 230 the application can transmit usage data relating to the third action to the server for entry into the interaction database. In step 235, the user can perform a fourth action that is inconsistent with the third action. For example, if the third action is clicking a button that directs the user to a different screen and the fourth action is the user clicking a back button or otherwise navigating back to the previous screen and clicking a different button that is located close to the initially clicked button, the fourth action can be considered inconsistent with the third action. As another example, if the third action is the user making a selection to start an operation and the fourth action is cancelling the operation, the fourth action can be considered inconsistent with the third action. The fourth action can be recorded as usage data by the application and can be transmitted to a server via a network for entry into an interaction database in step 240. The entry of the usage data relating to the fourth action can indicate that this action is considered negative reinforcement for the third action. The user can then perform a fifth action that is consistent with the third action (step 245) and usage data relating to the fifth action can be recorded by the application and sent to the server for entry into the interaction database as positive reinforcement for the third action (step 250).

The usage data entered into the interaction database can be used to train the predictive model as described herein. It is understood that the foregoing steps of sequence 200 can be repeated many times as usage data is accumulated. Once the predictive model has been adequately trained, the server can provide the predictive model to the user device in step 255 and the operation of the predictive model in support of the assistive interface can commence. In other embodiments, the predictive model need not be stored locally on the user device, and instead can operate to support the assistive interface while stored on the server or at another location. In those embodiments, it is sufficient for step 255 for the predictive model to commence operation in support of the assistive interface.

In step 260, the user can perform a sixth action that is inconsistent with the third action. Since the predictive model is operating in support of the assistive interface, the predictive model can override the sixth action in step 265 by, e.g., cancelling and/or undoing the sixth action and retuning the interface to its previous state prior to the performance of the sixth action. In step 270, the predictive model can perform a corrective action, such as one or more selected from the group of performing an action consistent with the third action, performing an action the predictive model predicts to be what the user likely intended, displaying a notification relating to one of the foregoing actions, displaying a notification asking whether the user intended to perform the sixth action, and displaying an option for the user to click to perform one or more actions that the predictive model considers to be consistent with the third action.

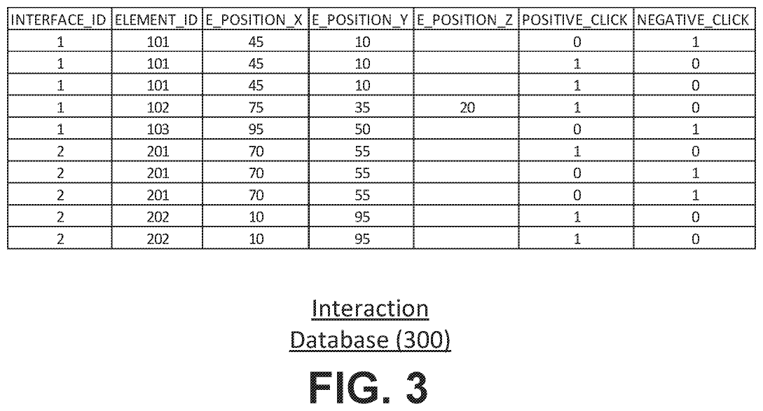

FIG. 3 illustrates a database schema of an interaction database 300 according to an example embodiment of the systems, methods, and computer-accessible mediums disclosed herein. The same or similar components as described with respect to other figures, including an interaction database. The interaction database 300 can include one or more interface tables containing usage data relating to one or more actions performed by the user with one or more interfaces.

The interaction database 300 can include a plurality of database values represented as columns that constitute usage data. For example, these can include an INTERFACE_ID, an ELEMENT_ID, an E_POSITION_X, an E_POSITION_Y, an E_POSITION_Z, a POSITIVE_CLICK, and a NEGATIVE_CLICK that comprise usage data relating to the actions performed by the user on one or more interfaces displayed on one or more client devices and recorded by one or more applications executing thereon. Although FIG. 3 illustrates the data values as numerical, the present disclosure is not limited thereto. It is understood that the data values can be binary, alphabetical, alphanumeric, or other data formats.

The INTERFACE_ID value can identify the particular interface on which the user performed an action. In some examples, each interface for which usage data is stored in the interaction database can be assigned a unique INTERFACE_ID value within the interaction database. The ELEMENT_ID value can identify a particular element displayed on the interface with which the user performed an action. In some examples, each element displayed on the interface can be assigned an ELEMENT_ID value. In some examples, each element for which usage data is stored in the interaction database can be assigned a unique ELEMENT_ID value within the interaction database. In other examples, ELEMENT_ID values can be repeated, but the combination of an INTERFACE_ID value and an ELEMENT_ID value for a particular element or object on a particular interface can be unique within the interaction database. In some examples, one or more of the ELEMENT_ID and/or INTERFACE_ID can be used to identify elements or objects by grouping or categories (e.g., buttons, type of button, links, type of links, text boxes, icons, etc.). This can allow for database querying for types or categories of elements or objects, to identify patterns, sequences of interactions, or other interaction information. In some examples, the time of each interaction can also be stored, so that time-based querying (e.g., interactions occurring within a certain period) and time-based sequencing can be performed. It is understood that interaction database 300 can be queried based on any combination of values and usage data.

The E_POSITION_X, E_POSITION_Y, and E_POSITION_Z values can identify x, y, and z values indicating the position of a particular element within an interface using a coordinate system. For example, within an x, y, z coordinate system having an origin at a fixed point within the interface (e.g., a corner, side, or center point), the E_POSITION_X value can indicate a positive or negative horizontal value, the E_POSITION_Y value can indicate a positive or negative vertical value, and the E_POSITION_Z value can indicate a positive or negative height value (within a three dimensional coordinate system). It is understood that one, two, or three coordinate systems can be used, and further understood that the origin can be fixed on any point within the interface. It is also understood that the interface is not restricted to square, rectangular, circular, or other regular shapes and can be an irregular shape, and that the coordinate system can be adapted to the regular or irregular shape accordingly.

In some examples, an element or object can be positioned within a virtual reality (VR) environment. As such, a coordinate system can be supplemented with additional information, such as person point-of-view, perspective, direction, and movement. In some examples, the position of an element or object within a VR environment can be tracked with six degrees of freedom, including rotational movements (pitch, yaw, and roll) and translational movements (forward and backward, left and right, and up and down), in addition to, or instead of, a coordinate system .

The POSITIVE_CLICK value can indicate whether the action is a positive reinforcement. Conversely, the NEGATIVE_CLICK value can indicate whether the action is a negative reinforcement. Further values can be included to identify which particular action the reinforcement applies. In some examples, the NEGATIVE_CLICK value can be omitted from the interaction database, and the POSITIVE_CLICK value can be a binary value, a positive or negative value, a yes/no value, or otherwise configured to indicate whether the reinforcement is positive or negative.

In some examples, additional values can be collected by the application and entered as usage data in the interaction database. Exemplary additional values include, without limitation, element type, element size, element shape, typing cursor velocity, typing cursor acceleration, mouse cursor velocity, mouse typing cursor acceleration, other input device cursor velocity, other input device cursor acceleration, directness of input device movement, indirectness of input device movement, click location, click speed, successful click attempts, and unsuccessful click attempts.

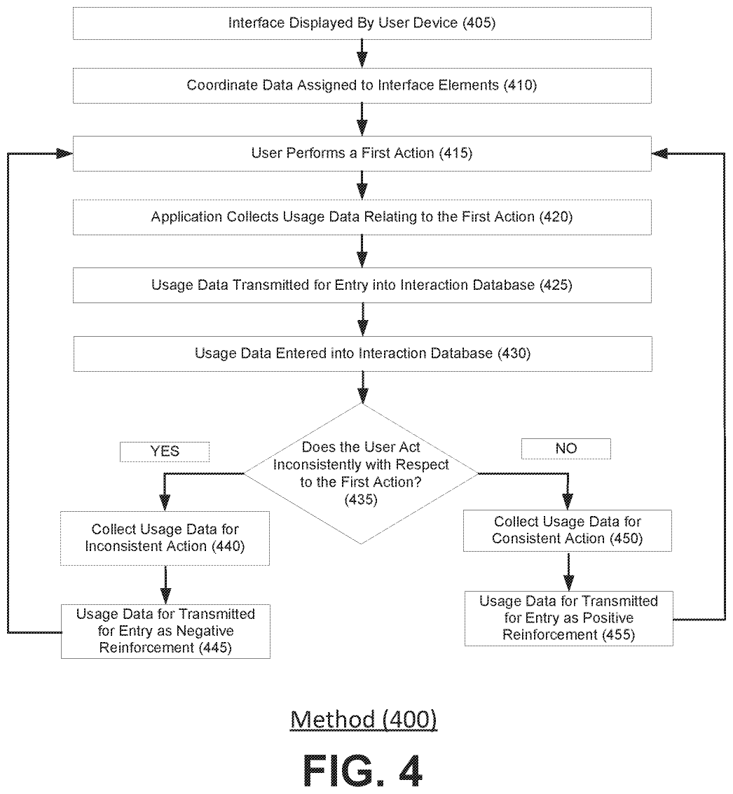

FIG. 4 is a flow chart of a method 400 for collecting usage data and entering usage data in an interaction database according to an example embodiment of the systems, methods, and computer-accessible mediums disclosed herein. FIG. 4 can reference the same or similar components as described with respect to other figures, including a user device, an interface, a server, an interaction database, and a predictive model.

The method 400 can commence with step 405, where an interface is displayed by the user device. The interface can display one or more elements, such as buttons, check boxes, windows, and scroll bars. In step 410, the position of the elements within the interface can be assigned identifiers and location values within a coordinate system overlaying the interface. These values can be assigned based on the type of usage data to be collected and can be formatted for entry into an interaction database.

In step 415, the user can perform a first action with the user interface, which can include one or more actions taken with one or more elements of the interface. An application executing on the user device can monitor the interface for user actions and, in step 420, the application can collect usage data relating to the first action. The application can be in data communication with the interaction database and, in step 425, the application can transmit the collected usage data for entry into the interaction database. The method can then proceed to step 435, where, since the application can be continuously monitoring the user's interaction with the interface and usage data can continue to be collected, the application can detect that the user has subsequently acted inconsistently to the first action. If so, the method 400 can proceed to step 440 and usage data can collect usage data for the inconsistent action. In step 445, the usage data for the inconsistent action can been transmitted by the application for entry into the interaction database as negative reinforcement for the first action. In some examples, the application can specify whether the usage data can be entered as negative reinforcement for the first action. In other examples, that determination can be made by the server or other device hosting the interaction database. The application can continue collecting usage data and the method 400 can return to step 415 when the user performs another action.

Returning to step 435, the application can detect that the user has subsequently acted consistently to the first action. In this case, the method 400 can proceed to step 450 and usage data can collect usage data for the consistent action. In step 455, the usage data for the inconsistent action can been transmitted by the application for entry into the interaction database as positive reinforcement for the first action. In some examples, the application can specify whether the usage data can be entered as positive reinforcement for the first action. In other examples, that determination can be made by the server or other device hosting the interaction database. The application can continue collecting usage data and the method 400 can return to step 415 when the user performs another action.

In this manner, user activity can be monitored and data can be collected. By the entry of data of positive reinforcement and negative reinforcement, the interaction database can be used can be used to train and develop the predictive model such that it can support the assistive interface.

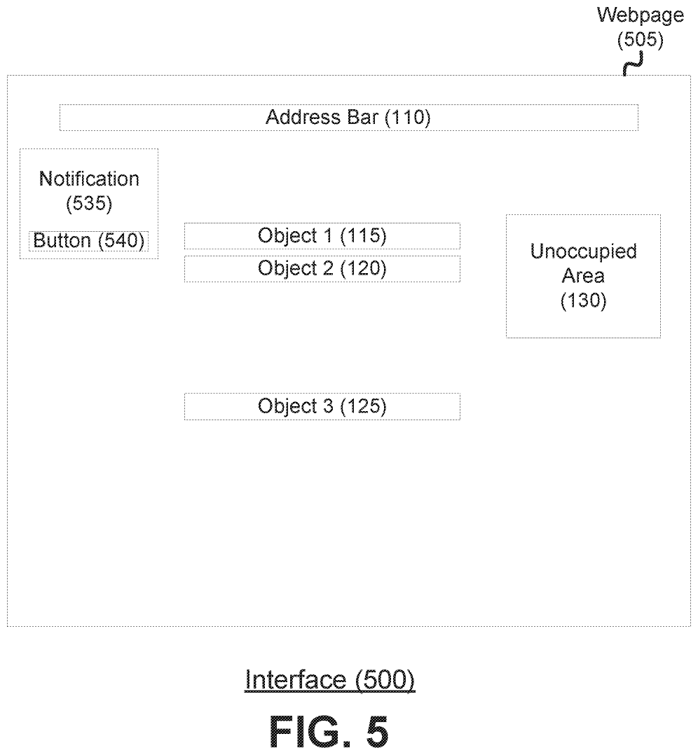

FIG. 5 illustrates an interface 500 according to an example embodiment of the systems, methods, and computer-accessible mediums disclosed herein. FIG. 5 can reference the same or similar components as described with respect to other figures, including a user device, an interface, a server, an interaction database, and a predictive model. FIG. 5 illustrates example embodiments of the operation an assistive interface by the exemplary system, method, and computer-accessible medium using an exemplary predictive model.

As shown in FIG. 5, the interface 500 can display a webpage 505 comprising multiple objects or elements. In some examples, webpage 505 can include an address bar 510, which can be selected by the user to enter a particular uniform resource locator (“URL”) for a particular website. Webpage 505 can include multiple objects 515, 520, and 525 (e.g., objects 1, 2, and 3) embedded thereon. As discussed above, objects 1-3 can be any object or an element, for example, an object or element that can be embedded on a webpage. As shown in FIG. 5, objects 1 and 2 are very close together, while object 3 is far from objects 1 and 2. If a user attempts to select object 3, the user will more than likely not accidentally select objects 1 and 2 due to the distance between object 3 and objects 1 and 2. However, since objects 1 and 2 are close together, a user attempting to select object 1 can accidentally select object 2, or vice versa. The exemplary system, method, and computer-accessible medium can track the mishits and apply the exemplary predictive model to determine whether an object was selected accidentally. For example, if a user attempting to select object 1 constantly accidentally selects object 2, and then reselects object 1 (e.g., by returning to webpage 505 after the incorrect selection of object 2), then the exemplary system, method, and computer-accessible medium can apply the exemplary predictive model to determine that the user is likely to misselect object 2 when attempting to select object 1. On subsequent attempts to select object 1, the exemplary system, method, and computer-accessible medium can correct the misselection of object 2 to object 1. Thus, the user need not be concerned with accidentally selecting object 2 when they intended to select object 1.

The systems, methods, and computer-accessible mediums according to example embodiments can be used to track the behavioral patterns of a particular user, or other users, of a particular content to determine how a user misselects the particular content. This information can be device specific. For example, misselects can be more common on devices with smaller displays. Thus, the exemplary predictive model can account for how misselects are likely to occur on devices with different size displays (e.g., a 10″ tablet as compared to a 4.5″ mobile phone). Profiles can be generated, which can be device specific, and can be generalized to other devices of a similar size. The exemplary system, method, and computer-accessible medium can also extrapolate profiles for new devices having a different size than existing devices for which a profile has already been generated. For example, the exemplary system, method, and computer-accessible medium can use one profile of a device having a 4.5″ display, and another profile for a device having a 10″ display, to extrapolate a profile (e.g., an initial profile) for a device have an 8″ display. The profile for the device having an 8″ display can then be updated as users operate and select objects on the device having the 8″ display.

In some examples, the exemplary predictive model can also determine a misselect that does not select another nearby object. For example, a user attempting to select object 1 shown in FIG. 5 can consistently, and accidentally, select unoccupied area 530. After unintentionally selection unoccupied area 530, the user can then select object 1. The exemplary predictive model can determine that the unintentional selection of unoccupied area 530 was meant to be a selection of object 1, and the exemplary system, method, and computer-accessible medium can automatically select object 1 based on the user's unintentional selection of unoccupied area 530. Thus, the exemplary system, method, and computer-accessible medium can artificially expand the region around certain objects on the display to correspond to a selection of the particular object intended to be selected.

The systems, methods, and computer-accessible mediums according to example embodiments can use a profile generated for a particular content (e.g., a particular webpage) in order to determine a misselection. The profile can be stored on the user's device, which can facilitate specific profiles for that user. For example, by tracking the behavior of the specific user with the specific content, the exemplary system, method, and computer-accessible medium can generate a profile based on the pattern of the behavior for the user, which can be based on the particular attributes of the user. For example, adults with larger fingers can be more likely to misselect an object than children with smaller fingers. Thus, specific information about the user, which can be gathered by the exemplary system, method, and computer-accessible medium at the initiation of the exemplary system, method and computer-accessible medium, can be used to generate the profile. User specific information can include, but is not limited to, age, gender, height, and weight. Additionally the profile can be based on medical conditions associated with the user, which can impact the user's ability to select an object. For example, users with Parkinson's disease can suffer from tremors that can make it difficult to select objects close to one another. The exemplary system, method, and computer-accessible medium can account for this impairment when determining how close objects on the display are when evaluating a misselect. For example, the distance between objects for a user without an impairment can be smaller than the distance between objects for a user with the impairment.

The systems, methods, and computer-accessible mediums according to example embodiments can track misselect information based on the behavior of the user after a selection, or misselection, occurs. For example, if a user does not click back in a browser when they select a particular object, this can be considered a positive reinforcement, as the exemplary system, method, and computer-accessible medium assumes that the user intentionally selected that particular object, or that the particular response was the desired result of the selection of an object. In contrast, if a user attempts to select an object, but the resulting action is not correct and the user then goes back to reselect the correct object, this can be considered a negative reinforcement for the exemplary system, method and computer-accessible medium. After a misselect is detected by the exemplary predictive model, the position that was originally selected can be identified in order to identify the correct object to be selected. The exemplary predictive model can then identify the correct position of the intended object to determine both the positive and negative reinforcement (e.g., the location of the misselected object and the location of the correct object). As more misselections are analyzed, the region tracked for misselections can be updated. Thus the region of the analyzed misselections can change dynamically depending on the user's behavior (e.g., how often they misselect a particular object).

The systems, methods, and computer-accessible mediums according to example embodiments can also be applied to a mouse input (e.g., by a mouse, trackpad, or trackball). Additionally, the exemplary system, method, and computer-accessible medium can also track the velocity and acceleration of the cursor moving toward the object to be selected. For example, if the object to be selected is a checkbox or a radio button, then the velocity and/or acceleration of the mouse cursor can impact whether or not the correct checkbox or radio button is selected. The exemplary system, method, and computer-accessible medium can also account for slow down time (e.g., did the cursor slowdown in time to select the correct checkbox or radio button).

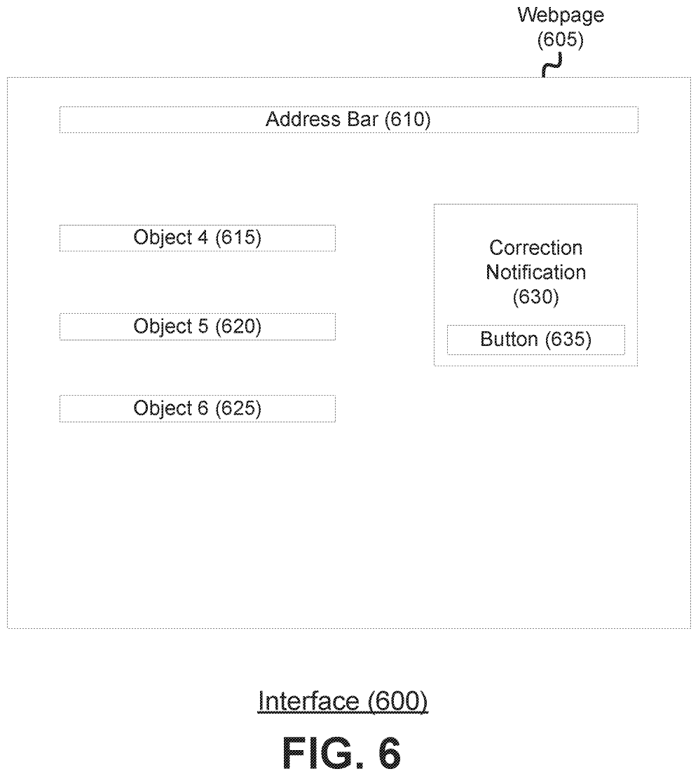

FIG. 6 illustrates an interface 600 according to an example embodiment of the systems, methods, and computer-accessible mediums disclosed herein. FIG. 6 can reference the same or similar components as described with respect to other figures, including a user device, an interface, a server, an interaction database, and a predictive model. FIG. 6 illustrates example embodiments of the operation an assistive interface by the exemplary system, method, and computer-accessible medium using an exemplary predictive model.

As shown in FIG. 6, the interface 600 can display a webpage 605 comprising multiple objects or elements. In some examples, webpage 605 can include an address bar 610, which can be selected by the user to enter a particular uniform resource locator (“URL”) for a particular website. Webpage 605 can include multiple objects 615, 620, and 625 (e.g., objects 4, 5, and 6) embedded thereon.

If a misselect is identified by the exemplary predictive model and corrected by the exemplary system, methods, and computer-accessible mediums, then the user can be informed of the correction. For example, if a user accidentally selects object 2 shown in FIG. 5, but intended to select object 1, as shown in FIG. 6, the exemplary system, method, and computer-accessible medium can correct this misselect, and navigate the user to webpage 605. The exemplary system, method, and computer-accessible medium can then provide a notification to the user that a correction was made. For example, a notification/popup 630 can be provided, which can be used to inform the user of the correction. Notification 630 can be visible for a certain period of time (e.g., 1 second, 5 seconds, 10, seconds, etc.), and after the period of time has expired, notification 630 can be hidden or removed. During the time that notification 630 is visible, button 635 can be displayed on or near notification 630. Button 635 can be selected by the user to inform the exemplary system, method, and computer-accessible medium that the correction was actually a mistake, and that the user intended to selected the supposedly corrected misselect (e.g., the exemplary system, method, and computer-accessible medium was incorrect in determining a misselect). Button 635 can navigate the user back to the previous page (e.g., webpage 505) where they can reselect the correct object. Alternatively, the exemplary system, method, and computer-accessible medium can track the URL of the object the exemplary system, method, and computer-accessible medium determined to be the incorrect object (e.g., the exemplary system, method, and computer-accessible medium can store the URL for object 2 in memory). Then, if the user selects button 635 indicating that the exemplary system, method, and computer-accessible medium was incorrect in correcting the selection, the exemplary system, method, and computer-accessible medium can navigate the user directly to the intended webpage (e.g., the webpage associated with object 2), without having to return to webpage 505.

When the exemplary predictive model identifies a misselect, as shown in FIG. 5, prior to navigating the supposedly correct webpage, a notification/popup 535 can be provided indicating to the user that the exemplary system, method, and computer-accessible medium is correcting the misselect (e.g., indicating that the exemplary system, method, and computer-accessible medium is actually selecting object 1 rather than object 2). If no action is taken by the user after a predetermined amount of time (e.g., 1 second, 5 seconds, 10, seconds, etc.) then the exemplary system, method, and computer-accessible medium can automatically navigate to the corrected webpage (e.g., webpage 505) based on the corrected selected object. However, if the user selects notification 535, or selects button 540 on notification 535), then the correction can be cancelled, and the user can be navigated to the intended webpage based on the selection of the actually intended object.

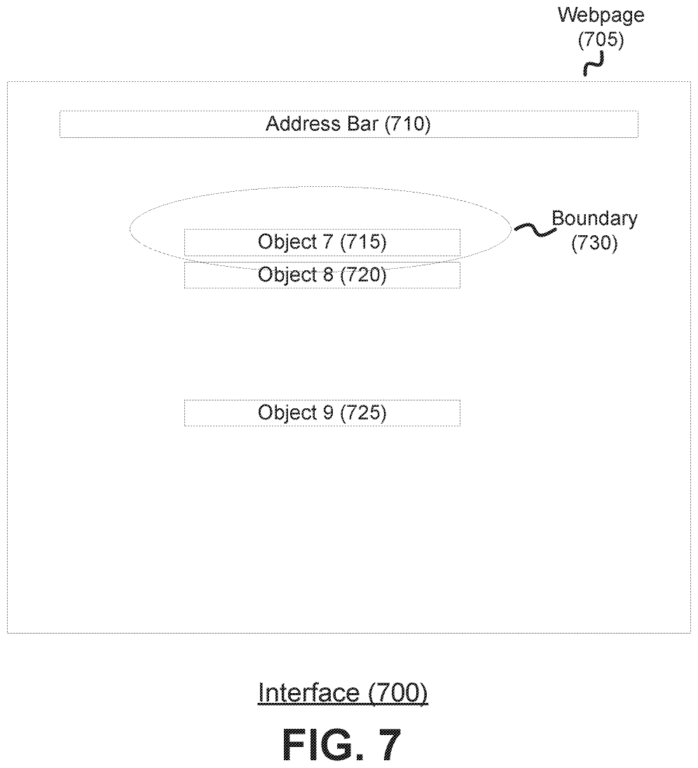

FIG. 7 illustrates an interface 700 according to an example embodiment of the systems, methods, and computer-accessible mediums disclosed herein. FIG. 7 can reference the same or similar components as described with respect to other figures, including a user device, an interface, a server, an interaction database, and a predictive model. FIG. 7 illustrates example embodiments of the operation an assistive interface by the exemplary system, method, and computer-accessible medium using an exemplary predictive model.

As shown in FIG. 7, the interface 700 can display a webpage 705 comprising multiple objects or elements. In some examples, webpage 705 can include an address bar 710, which can be selected by the user to enter a particular uniform resource locator (“URL”) for a particular website. Webpage 705 can include multiple objects 715, 720, and 725 (e.g., objects 4, 5, and 6) embedded thereon.

As shown in FIG. 7, the exemplary system, method, and computer-accessible medium can determine a boundary 730 that surrounds the object (e.g., object 7). If the user selects any object within boundary 730 (e.g., object 8), the exemplary system, method, and computer-accessible medium can correct the selection and actually select object 7. Any object not within boundary 730 (e.g., object 9) will not be corrected. Additionally, no correction will be made if the user selects the portion of object 8 not within boundary 730. As shown in FIG. 7, boundary 730 is elliptical. However, boundary 730 can be circular, square, or any other uniform or non-uniform shape that surrounds the intended object to be selected. The boundary can be determined based on the prior misselections by the user, and can be dynamically updated. For example, boundary 730 can be initiated as an ellipse, but can change to an alternative shape (e.g., another uniform or non-uniform shape) as misselects are identified by the exemplary system, method and computer-accessible medium.

The boundary can be any text near or associated with a checkbox or radio button. For example, it is common for checkboxes and radio buttons to have text near them, which indicated what the selection represents (e.g., gender, age, etc.). Some programmers program the text to also be selectable, meaning that when the text associated with a checkbox or radio button is selected, then the checkbox or radio button is also selected. However, some programmers do not program such a feature. In such a case, the exemplary system, method and computer-accessible medium, according to an exemplary embodiment of the present disclosure, can set a boundary to be the text near the checkbox or radio button. Thus, when the user selects the text, the exemplary system, method, and computer-accessible medium will automatically select the checkbox or radio button.

In some examples, the exemplary system, method and computer-accessible medium can utilize a heat map that surrounds a particular object (e.g., object 7) to determine misselects. A heat map is a graphical representation of data where the individual values contained in a matrix are represented as colors. This can aid in determining where misselects are more likely to occur. Additionally, the exemplary system, method, and computer-accessible medium can generate a cluster map (e.g., a map that includes a point on the screen where the user attempts to select object 7). This can also aid the exemplary system, method, and computer-accessible medium in determining where misselects are more likely to occur.

The exemplary system, method and computer-accessible medium, according to an exemplary embodiment of the present disclosure, can generate a profile that is specific to the content being interacted with and/or the device the content is displayed on. These profile can be used to determine misselects by the user of the device of specific content. These profiles can also be used to determine misselects in other similar content or on other devices owned or operated by the user. Thus, the profiles can be generalized to more than just the specific content or device used to generate the profiles. Additionally, profiles generated by other users on other devices and on other content can be used to generate and/or update the profiles associated with a particular user. For example, the exemplary system, method, and computer-accessible medium can utilize a machine learning procedure, as discussed below, which can use multiple profiles from different users, different devices, and different content, to generate and/or update the profiles.

The profile generated by the exemplary system, method, and computer-accessible medium can also be updated based on the number of times a user attempts to select an object before the object is actually selected. For example, it is common for the user to attempt to select an object, but no object is actually selected. This can be because the area that can appear to be selected (e.g., indicated by a picture, button, etc.) can actually be larger than the area that can actually be selected, which can be set by the programmer of the interface. For example, a button to be selected can be 1″ by 1″, but only the middles area of the button that is ½″ by ½″ can actually be selected. When attempting to select the button, the user can select the button itself many times before actually selecting the area that initiates the button select. The exemplary system, method, and computer-accessible medium can keep track of the number of times the user attempts to select a button when generating a profile. In such a scenario, the exemplary system, method, and computer-accessible medium can set the boundary the size of the actual button, even though the area that can be selected by the programmer can be smaller than the size of the button. The exemplary system, method, and computer-accessible medium can also utilize the time between selections when generating a profile. For example, rapid selections by a user can indicate that the user is attempting to select an object, but is unsuccessful. However, a greater amount of time can indicate that the user is not unsuccessfully trying to select an object.

In some examples, the exemplary system, method and computer-accessible medium can also utilize the pressure applied by the user when selecting an object. Pressure detecting touch systems enable trackpads and touchscreens to distinguish between various levels of force being applied to their surfaces. Pressure sensors can be used the register the amount of force or pressure a user uses to select an object. When a user is unsuccessful in selecting an object, it can be common for them to press a touchscreen harder in order to select an object. The exemplary system, method and computer-accessible medium, according to an exemplary embodiment of the present disclosure, can use this information to determine that a user is having difficult selecting an object. Profiles can be generated or updated based on the pressure applied by the user when they attempt to select an object.

The exemplary system, method and computer-accessible medium can utilize machine learning in connection with the exemplary predictive model to determine misselects by the user in order to correct the misselect. The exemplary machine learning can utilize information from the specific user, as well as other users that have interacted with the same or similar content (e.g., the same or similar webpages) to determine misselects (e.g., the boundary around an object) in the training and operation of the exemplary predictive models.

The exemplary system, method and computer-accessible medium can utilize various neural network, such as convolutional neural networks (“CNN”) or recurrent neural networks (“RNN”) to generate the exemplary predictive models. A CNN can include one or more convolutional layers (e.g., often with a subsampling step) and then followed by one or more fully connected layers as in a standard multilayer neural network. CNNS can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that cannot be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

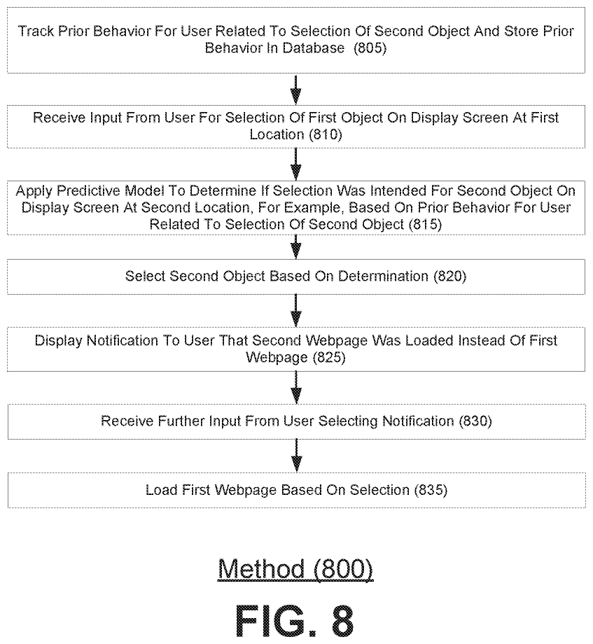

FIG. 8 is a flow diagram of a method 800 of operating an assistive interface according to an example embodiment of the systems, methods, and computer-accessible mediums disclosed herein. FIG. 8 can reference the same or similar components as described with respect to other figures, including a user device, an interface, a server, an interaction database, and a predictive model.

As shown in FIG. 8, at procedure 805, prior behavior for the user related to the selection of the second object can be tracked and stored in a database. At procedure 810, input from a user for a selection of a first object on a display screen at a first location can be received. At procedure 815, a predictive model can be applied to make a determination as to whether the selection was intended for a second object on the display screen at a second location, for example, based on prior behavior for the user related to the selection of the second object. At procedure 820, the second object can be selected based on the determination. At procedure 825, a notification can be displayed to the user that the second webpage was loaded instead of the first webpage. At procedure 830, a further input can be received from the user selecting the notification. At procedure 835, the first webpage can be loaded based on the selection.

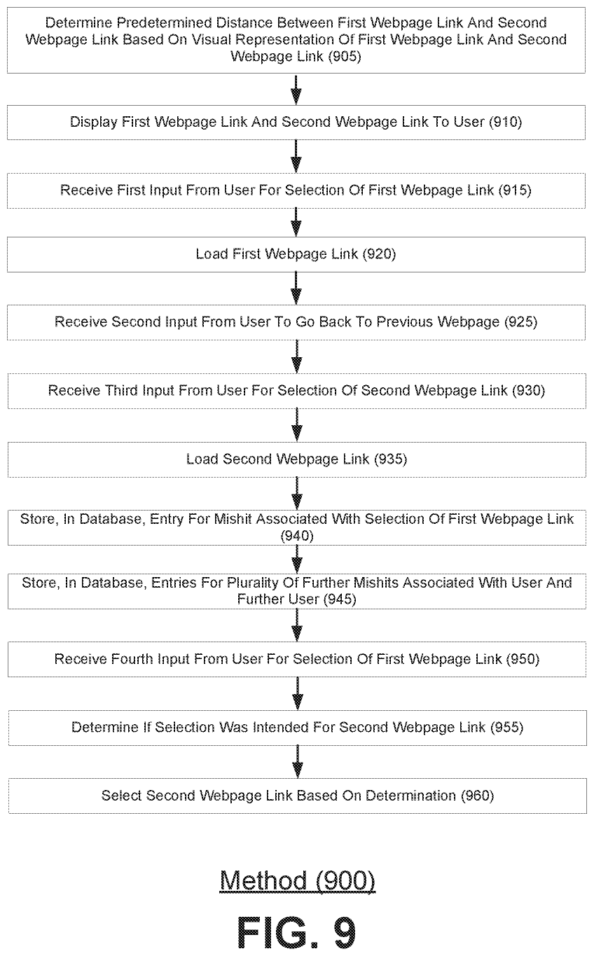

FIG. 9 is a flow diagram of a method 900 of operating an assistive interface according to an example embodiment of the systems, methods, and computer-accessible mediums disclosed herein. FIG. 9 can reference the same or similar components as described with respect to other figures, including a user device, an interface, a server, an interaction database, and a predictive model.

As shown in FIG. 9, at procedure 905, a predetermined distance between a first webpage link and a second webpage link can be determined based on a visual representation of the first webpage link and the second webpage link. At procedure 910, the first webpage link and the second webpage link can be displayed to a user. At procedure 915, a first input can be received from the user for a selection of a first webpage link. At procedure 920, the first webpage link can be loaded. At procedure 925, a second input from the user to go back to a previous webpage can be received. At procedure 930, a third input from the user for the selection of a second webpage link can be received. At procedure 935, the second webpage link can be loaded.

Additionally, as shown in FIG. 9, at procedure 940, an entry for a mishit associated with the selection of the first webpage link can be stored in an interaction database. At procedure 945, entries for a plurality of further mishits associated with the user and a further user can be stored in the interaction database. At procedure 950, a fourth input from the user for the selection of the first webpage link can be received. At procedure 955, a determination can be made by a predictive model as to whether the selection was intended for the second webpage link. At procedure 960, the second webpage link can be selected based on the determination.

In some examples, reference is made to a webpage as an example of a type of interface. The present disclosure is not limited to webpages, however, and it is understood that the example embodiments of the present disclosure include any type of interface that displays elements, objects, or text, including without limitation any type of graphical user interface and any type of textual interface.

The present disclosure is not to be limited in terms of the particular embodiments described in this application, which are intended as illustrations of various aspects. Many modifications and variations can be made without departing from its spirit and scope, as can be apparent. Functionally equivalent methods and apparatuses within the scope of the disclosure, in addition to those enumerated herein, can be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1. A non-transitory computer-accessible medium having stored thereon computer-executable instructions wherein, when a computer hardware arrangement executes the instructions, the computing arrangement is configured to perform procedures comprising:
assigning first location data to a first object at a first location on a display screen and assigning second location data to a second object at a second location on a display screen;
receiving at least one input from at least one user for a selection of the first object on a display screen at a first location;
applying a predictive model to determine if the selection was intended for the second object on the display screen, wherein:
the determination is based on the first location data, the second location data, and prior behavior of the at least one user related to a selection of the second object,
the prior behavior of the at least one user comprises a plurality of prior actions,
each of the plurality of prior actions is performed in response to at least one prior user interaction, and
each of the plurality of prior actions is categorized as a positive reinforcement or a negative reinforcement; and
selecting the second object based on the determination.

2. (canceled)

3. The computer-accessible medium of claim 1, wherein:
the first object is a webpage link, a button, or a checkbox, and
the second object is a webpage link, a button, or a checkbox.

4. (canceled)

5. (canceled)

6. The computer-accessible medium of claim 1, wherein the second location is within a predetermined distance from the first location.

7. (canceled)

8. The computer-accessible medium of claim 1, wherein the computing arrangement is further configured to:
track the prior behavior for the at least one user related to the selection of the second object, and
store the prior behavior in a database,
wherein the prior behavior comprises the velocity and acceleration of a mouse cursor with respect to the selection of the second object.

9. The computer-accessible medium of claim 1, wherein the first object is a first link to a first webpage and the second object is a second link to a second webpage, and wherein the computing arrangement is further configured to load the second webpage after the second object is selected.

10. The computer-accessible medium of claim 9, wherein the computing arrangement is further configured to display at least one notification to the at least one user that the second webpage was loaded instead of the first webpage.

11. The computer-accessible medium of claim 10, wherein the computing arrangement is further configured to:
receive at least one further input from the at least one user selecting the at least one notification, and
load the first webpage based on the selection.

12. A method, comprising:
receiving a first input from a user for a selection of a first webpage link;
loading the first webpage link;
receiving a second input from the user to go back to a previous webpage;
receiving a third input from the user for the selection of a second webpage link;
loading the second webpage link;
applying a predictive model to determine if the selection of the first webpage link was intended for the second webpage link, wherein:
the determination is based on prior behavior of at least one user related to a selection of the second webpage link,
the prior behavior of the at least one user comprises a plurality of prior actions,
each of the plurality of prior actions is performed in response to at least one prior user interaction, and
each of the plurality of prior actions is categorized as a positive reinforcement or a negative reinforcement
storing, in a database, an entry for a mishit associated with the selection of the first webpage link, wherein the entry for the mishit associated with the selection of the first webpage link is categorized as a negative reinforcement; and
storing, in the database, an entry for a hit associated with the selection of the second webpage link, wherein and the entry for the hit associated with the selection of the second webpage link is categorized as a positive reinforcement.

13. The method of claim 12, wherein the first input is a first touch input, a first mouse input, a first trackball input, or first a visual input and the second input is a second touch input, a second mouse input, a second trackball input, or a second visual input.

14. The method of claim 12, further comprising displaying the first webpage link and the second webpage link to the user.

15. The method of claim 12, wherein the first webpage link is located within a predetermined distance from the second webpage link.

16. The method of claim 15, further comprising determining the predetermined distance based on a visual representation of the first webpage link and the second webpage link.

17. The method of claim 12, further comprising storing, in the database, entries for a plurality of further mishits associated with the user and at least one further user.

18. The method of claim 12, further comprising:
receiving a fourth input from the user for the selection of the first webpage link;
determining if the selection was intended for the second webpage link; and
selecting the second webpage link based on the determination.

19. The method of claim 18, wherein the determining if the selection was intended for the second webpage link is based on the entry stored in the database.

20. A system, comprising:
a display device configured to display a first object at a first location on the display device and a second object at a second location on the display device, wherein the first location is different from the second location;
an input device configured to receive an input from a user for a selection of the second object;
an interaction database containing usage data relating to one or more user interactions with one or more objects; and
a computing arrangement configured to:
assign first location data to the first object and assign second location data to the second object;
apply a predictive model to determine if the selection was intended for the first object, wherein:
the determination is based on the location data and interaction data contained in an interaction database,
the interaction data comprises a plurality of prior actions,
each of the plurality of prior actions is performed in response to at least one prior user interaction, and
each of the plurality of prior interactions is categorized as a positive reinforcement or a negative reinforcement; and
select the first object based on the determination.

21. The computer-accessible medium of claim 1, wherein the computing arrangement is further configured to:
generate a first heat map with reference to the first object comprising a first graphical representation of a first plurality of individual data values contained in a first matrix,
generate a second heat map with reference to the second object comprising a second graphical representation of a second plurality of individual data values contained in a second matrix, and
the determination by the predictive model if the selection was intended for the second object is further based on the first heat map and the second heat map.

22. The computer-accessible medium of claim 21, wherein the computing arrangement is further configured to:
generate a cluster map comprising at least one point on the display screen where the at least one user attempted to select the first object, and
the determination by the predictive model if the selection was intended for the second object is further based on the cluster map.

23. The computer-accessible medium of claim 1, wherein the positive reinforcement categorization includes classifying at least one of the plurality of prior actions as consistent with at least one prior user interaction.

24. The computer-accessible medium of claim 1, wherein the negative reinforcement categorization includes classifying at least one of the plurality of prior actions as inconsistent with at least one prior user interaction.
